(19) United States
(12) Patent Application Publication
(10) Pub. No.: US 2024/0416432 A1
(43) Pub. Date: Dec. 19, 2024

(54) ADJUSTABLE BUSHING ASSEMBLY FOR HOLE LOCATION AND DRILLING

(71) Applicant: The Boeing Company, Arlington, VA (US)

(72) Inventor: Edward John Batt, Boerne, TX (US)

(73) Assignee: The Boeing Company, Arlington, VA (US)

(21) Appl. No.: 18/336,238

(22) Filed: Jun. 16, 2023

(51) Int. Cl. B23B 47/28

(52) U.S. Cl. CPC B23B 47/287

(57) ABSTRACT

A drill template includes a tooling plate defining a first aperture extending through the plate along a first axis. The template also includes an adjustable bushing assembly having an outer eccentric element arranged rotatably inside the first aperture and defining a second aperture disposed along a second axis. The template additionally includes an inner eccentric element arranged rotatably inside the second aperture and defining a third aperture disposed along a third axis. The first, second, and third axes are spaced apart from each other. The template also includes a drill bushing arranged inside the third aperture and defining a fourth aperture disposed along a fourth axis. The bushing is configured to swivel relative to the inner eccentric element to orient the fourth aperture relative to the tooling plate. The template further includes a system of fasteners for setting the bushing position relative to the plate for guiding a drill bit.

### GOVERNMENT LICENSE RIGHTS

This invention was made with Government support under contract N00019-18-D-0001 awarded by Department of Defense. The Government has certain rights in this invention.

### INTRODUCTION

The present disclosure relates to an adjustable position bushing assembly for hole location on a drill template.

Drill templates or jigs are used in many different industries to expedite repetitive hole center locations on multiple interchangeable parts to guide a boring tool into precise location of each intended hole center. Drill templates typically define fixed hole patterns, such that every component generated using the same template will have an identical mounting interface to enable interchangeable fitment with mating parts. Overall, drill templates facilitate consistent quality of manufactured products due to low dimensional variability and provide an increase in production and interchangeability of parts. In metalworking practice, a hardened drill bushing typically lines each hole on the drill template to guide, position, and support the cutting tool, and keep the tool from damaging the jig.

### SUMMARY

A drill template includes a tooling plate having a first side, an opposite second side, and a plate thickness between the first and second sides. The tooling plate defines a first aperture extending through the plate thickness along a first axis. The first axis is perpendicular to each of the first and second sides. The drill template also includes an adjustable bushing assembly having an outer eccentric element arranged rotatably inside the first aperture and defining a second aperture disposed along a second axis. The second axis is parallel to and is spaced apart from the first axis. The drill template additionally includes an inner eccentric element arranged rotatably inside the second aperture and defining a third aperture disposed along a third axis. The third axis is parallel to and is spaced apart from each of the first and second axes. The drill template also includes a drill bushing arranged inside the third aperture and defining a fourth aperture disposed along a fourth axis. The drill bushing is configured to swivel relative to the inner eccentric element to orient the fourth aperture relative to the first and second sides of the tooling plate. The drill template further includes a system of fasteners configured to set the drill bushing in position relative to the first and second sides of the tooling plate for guiding a drill bit via the fourth aperture.

The system of fasteners may include a drill bushing lock fastener configured to fix the drill bushing in position relative to the inner eccentric element. The system of fasteners may also include an eccentric lock fastener configured to simultaneously fix each of the outer eccentric element and the inner eccentric element in position relative to the tooling plate. The system of fasteners may additionally include one or more bushing assembly lock fasteners configured to fix the bushing assembly within the tooling plate in position relative to the first aperture.

Each of rotation of the outer eccentric element inside the first aperture, rotation of the inner eccentric element inside the outer eccentric element, and swiveling of the drill bushing inside the inner eccentric element may adjust the position of the drill bushing relative to the tooling plate.

The third aperture may include a socket portion. The drill bushing may include a drill bushing body having a spherical portion configured to seat against and swivel within the socket portion.

The drill template may additionally include a locking ring having an inner surface arranged adjacent the socket portion of the third aperture. The locking ring may be configured to contact and lock the spherical portion of the drill bushing body via tightening of the drill bushing lock fastener.

The drill bushing lock fastener may be configured to tighten and fix the locking ring against the spherical portion of the drill bushing body.

The eccentric lock fastener may include a conical portion.

The eccentric lock fastener may be a screw having a threaded shaft and a cap. In such an embodiment, the conical portion may be a sleeve threaded onto the threaded shaft and seated against the cap of the eccentric lock screw.

The adjustable bushing assembly may additionally include an eccentric lock bushing having an internal taper configured to engage the conical portion of the eccentric lock fastener. The eccentric lock bushing may additionally include radial serrations configured to facilitate expansion of the eccentric lock bushing inside the outer eccentric element and against the inner eccentric element.

The eccentric lock bushing may be constructed from copper.

The system of fasteners may be configured to engage the tooling plate from the first side. The first aperture may include a step arranged proximate the second side and configured to provide a positive stop for the outer eccentric element along the first axis.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of a drill template having a tooling plate with adjustable bushing assemblies for setting a drill hole pattern, according to the present disclosure.

FIG. 2 is a schematic perspective close-up partial view of the drill template shown in FIG. 1, depicting elements of one of the adjustable bushing assemblies, according to the disclosure.

FIG. 3A is a schematic close-up cross-sectional view of the adjustable bushing assembly shown in FIG. 2, including a section view of a drill bushing and a locking ring, according to the disclosure.

FIG. 3B is a schematic perspective view of the drill bushing and the locking ring shown in FIG. 3A, according to the disclosure.

FIG. 4A is a schematic close-up cross-sectional view of the adjustable bushing assembly shown in FIG. 2, including a section view of an eccentric lock fastener and an eccentric lock bushing, according to the disclosure.

FIG. 4B is a schematic perspective view of the eccentric lock fastener and the eccentric lock bushing shown in FIG. 4A, according to the disclosure.

FIG. 5 is a schematic close-up cross-sectional view of the adjustable bushing assembly shown in FIG. 2.

### DETAILED DESCRIPTION

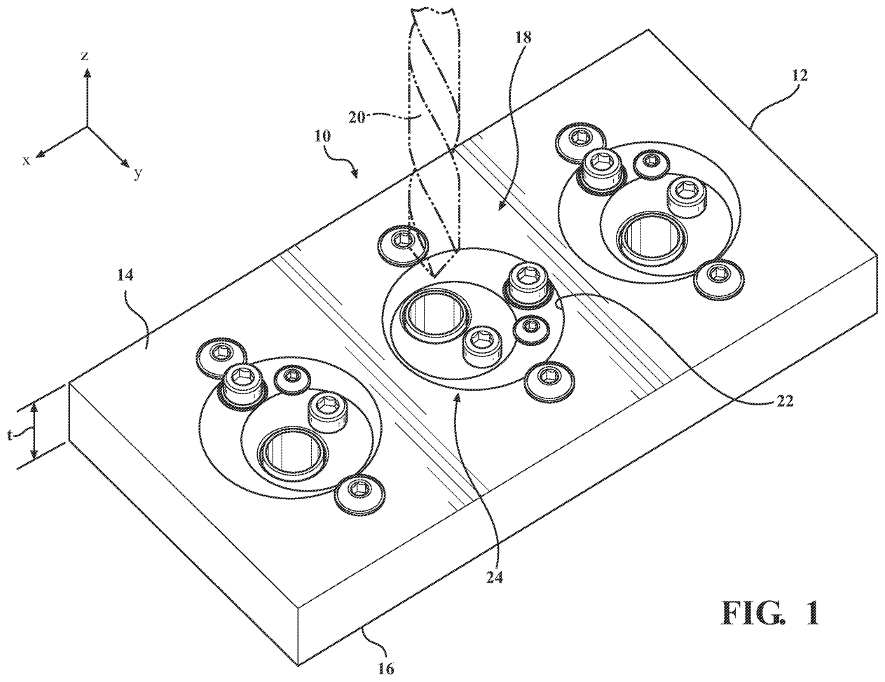

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Referring to the drawings, wherein like reference numbers refer to like components, FIG. 1 shows an embodiment of a drill template 10 having a tooling plate 12 arranged in an X-Y-Z coordinate space. The tooling plate 12 includes a first side 14 and an opposite, substantially parallel second side 14. The tooling plate 12 has a plate thickness t between the first and second sides 14, 16. The drill template 10 also has an adjustable drill hole pattern 18, which may be generated via a drill bit 20.

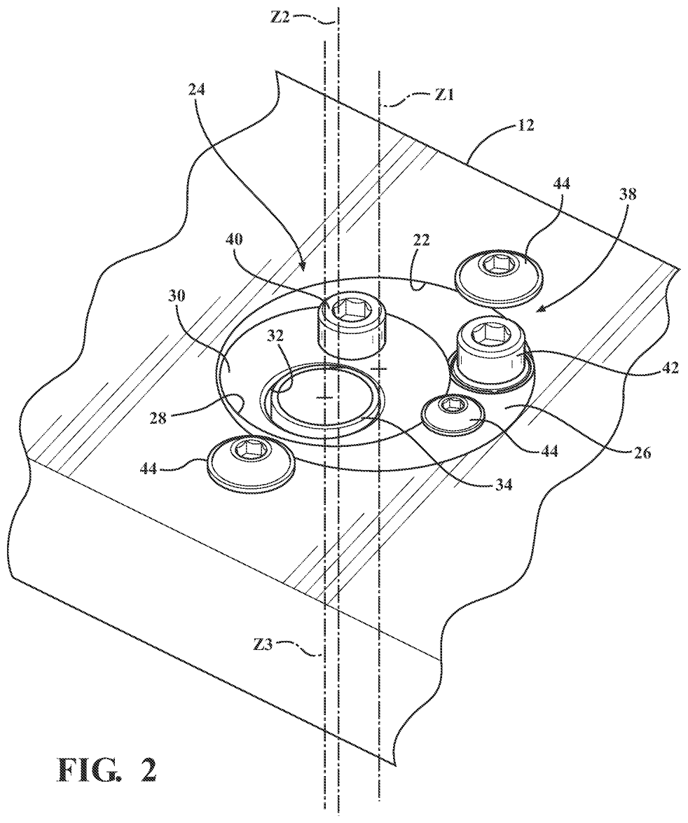

As shown in FIG. 1, the tooling plate 12 defines a plurality of first apertures 22. Each first aperture 22 extends through the plate thickness t along a respective first axis Z1. The first axis Z1 is perpendicular to each of the first and second sides 14, 16. The drill template 10 also includes a plurality of adjustable bushing assemblies 24 configured to establish the adjustable drill hole pattern 18. As shown in FIG. 2, each adjustable bushing assembly 24 includes an outer eccentric element 26. The outer eccentric element 26 is arranged rotatably inside the respective first aperture 22 and defines a second aperture 28 disposed along a second axis Z2. The second axis Z2 is parallel to and is spaced apart from the first axis Z1. Each adjustable bushing assembly 24 also includes an inner eccentric element 30 arranged rotatably inside the second aperture 28. The inner eccentric element 30 defines a third aperture 32 disposed along a third axis Z3. The third axis Z3 is parallel to and is spaced apart from each of the first and second axes Z1, Z2.

With continued reference to FIG. 2, each adjustable bushing assembly 24 additionally includes a drill bushing 34 arranged inside each third aperture 32. The drill bushing 34 has a drill bushing body 34A, which defines a fourth aperture 36 disposed along a fourth axis ZA. The drill bushing 34 is configured to swivel in the X-Y-Z coordinate space relative to the inner eccentric element 30 to orient the fourth aperture 36 relative to the first and second sides 14, 16 of the tooling plate 12. Each adjustable bushing assembly 24 further includes a system of fasteners 38 configured to set the drill bushing 34 in position relative to the first and second sides 14, 16 of the tooling plate 12 for guiding a drill bit 20 via the fourth aperture 36. The system of fasteners 38 may specifically include a drill bushing lock fastener 40 configured to fix the drill bushing 34 in position relative to the inner eccentric element 30.

The system of fasteners 38 may also include an eccentric lock fastener 42 configured to simultaneously fix each of the outer eccentric element 26 and the inner eccentric element 30 in position relative to the tooling plate 12. The system of fasteners 38 may further include at least one, but more specifically two or three, bushing assembly lock fasteners 44. The bushing assembly lock fasteners 44 may be configured to fix and retain the bushing assembly 24 within the tooling plate 12 in position relative to the first aperture 22. Specifically, each of the lock fasteners 44 may be configured as screws having respective caps 44-1. As shown, two of the bushing assembly lock fasteners 44 may be threaded into the tooling plate 12 and have their screw caps 44-1 overlap a portion of the outer eccentric element 26, while the third bushing assembly lock fastener may be threaded into the outer eccentric element 26 and having its screw cap 44-1 overlap a portion of the inner eccentric element 30, to thereby retain each of the respective eccentric elements in the tooling plate 12. Swiveling of the drill bushing 34 inside the inner eccentric element 30 together with rotation of the outer eccentric element 26 inside the first aperture 22, and rotation of the inner eccentric element inside the outer eccentric element 26 adjusts the position of the drill bushing relative to the tooling plate 12.

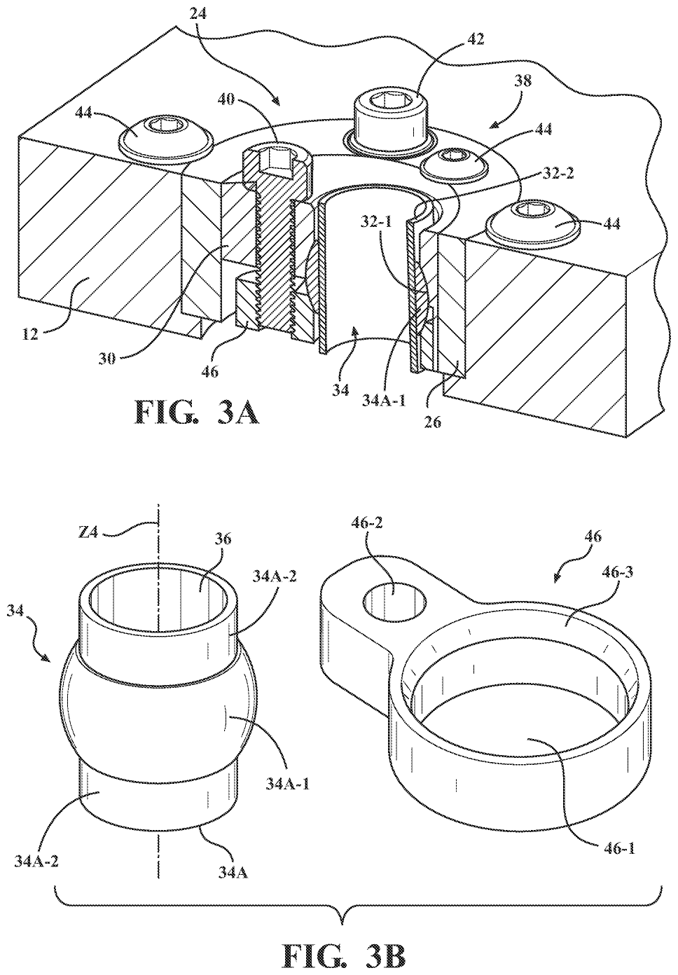

With reference to FIG. 3A, the third aperture 32 (within the inner eccentric element 30) includes a socket portion 32-1, and a bore portion 32-2. The drill bushing body 34A (shown in FIG. 3B) has a spherical portion 34A-1 and a cylindrical portion 34A-2. The spherical portion 34A-1 is configured to seat against and swivel within the socket portion 32-1 of the third aperture 32. The drill bushing body 34A may be formed or machined from a single piece of material, such as tube stock, or have a separate spherical portion 34A-1 pressed onto the cylindrical portion 34A-2. Each adjustable bushing assembly 24 may additionally include a locking ring 46 defining an aperture 46-1 for positional clearance of the drill bushing 34 and an eyelet 46-2 threaded to accept the drill bushing lock fastener 40 (shown in FIG. 3B).

As shown, the locking ring 46 also includes a chamfered or rounded inner surface 46-3 arranged concentrically with and adjacent to the socket portion 32-1 of the third aperture 32. As shown in FIG. 3A, the locking ring inner surface 46-3 is configured to come into contact with and lock the spherical portion 34A-1 of the drill bushing body 34A via tightening of the drill bushing lock fastener 40. Specifically, as shown, the drill bushing lock fastener 40 may extend through the inner eccentric element 30 and into the locking ring 46 to sandwich the spherical portion 34A-1 of the drill bushing 34 between the socket portion 32-1 of the inner eccentric element and the inner surface 46-3 of the locking ring 46. Subsequent tightening of the drill bushing lock fastener 40 is intended to clamp and fix the drill bushing body 34A in position by the locking ring inner surface 46-3 being forced against the spherical portion 34A-1 of the drill bushing body.

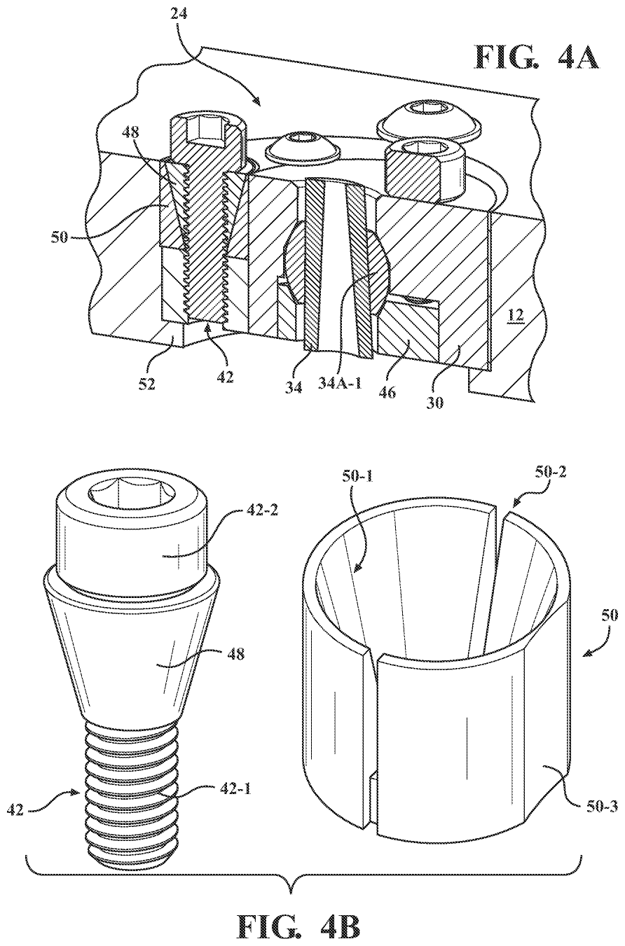

As shown in FIGS. 4A and 4B, the eccentric lock fastener 42 may include a conical portion 48. As shown in FIG. 4B, the eccentric lock fastener 42 may be a screw having a threaded shaft 42-1 and a cap 42-2. The conical portion 48 may be a sleeve threaded onto the threaded shaft 42-1 and seated against the cap 42-2 of the eccentric lock screw. Each adjustable bushing assembly 24 may additionally include an eccentric lock bushing 50. The eccentric lock bushing 50 may have an internal taper 50-1 configured to engage the conical portion 48 of the eccentric lock fastener 42 and radial serrations 50-2 configured to facilitate expansion of the eccentric lock bushing inside the outer eccentric element 26 and against the inner eccentric element 30. As shown, the eccentric lock bushing 50 may additionally have a flat section or side 50-3 configured to contact the outer surface of inner eccentric element 30 and thereby fix the inner eccentric element relative to the outer eccentric element 26. The eccentric lock bushing 50 may be constructed from copper.

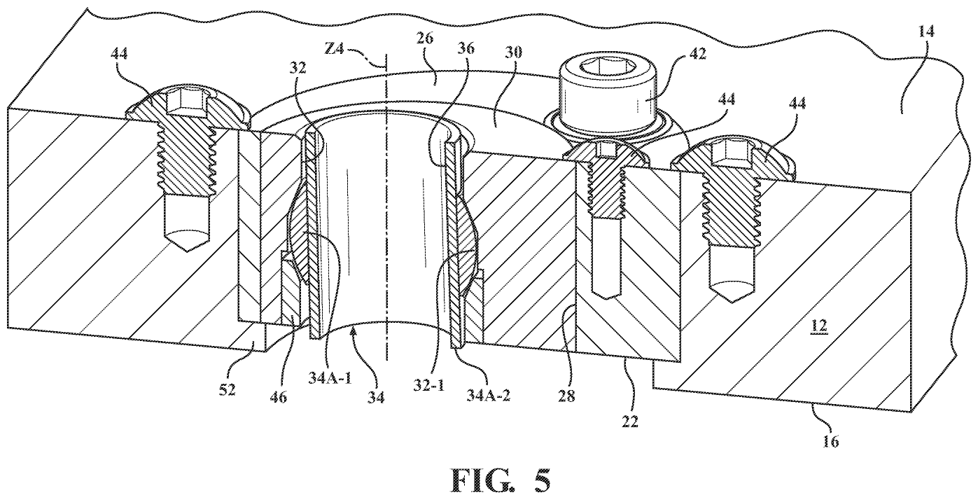

The system of fasteners 38 may be configured to engage the tooling plate 12 from the first side 14. As shown in FIG. 5, each of the first apertures 22 may be configured as a stepped bore, i.e., the tooling plate 12 may include a step 52 arranged at the bottom of the first aperture proximate the plate's second side 16. The step 52 is configured to provide a positive stop for the outer eccentric element 26 along the first axis Z1. As the outer eccentric element 26 is loaded against the step 52, the adjustable bushing assembly 24 becomes retained within the tooling plate 12. The lock fasteners 40, 42, 44 may then be tightened to fix desired positions of the respective locking rings 46, the outer eccentric elements 26, and the bushing assemblies 24 on the tooling plate 12 to set the drill hole pattern 18.

Overall, the adjustable bushing assemblies 24 are configured to provide a drill template with capability to set and reset a drill hole pattern thereon. Each of the adjustable bushing assemblies includes a system of rotatable, non-concentrically positioned elements (outer eccentric element, inner eccentric element, and drill bushing) permitting such an adjustment of the drill hole pattern. A system of fasteners and complementary locking components (locking ring 46, conical portion 48, lock bushing 50) is employed to permit adjustment of relative position of the rotatable elements and retention thereof in the drill template. Positions of individual bushing assemblies may be readjusted relative to one another to modify the drill hole pattern without necessitating construction of a new drill template.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A drill template comprising:
a tooling plate having a first side, an opposite second side, and a plate thickness between the first and second sides, wherein the tooling plate defines a first aperture extending through the plate thickness along a first axis, and wherein the first axis is perpendicular to each of the first and second sides; and
an adjustable bushing assembly including:
an outer eccentric element arranged rotatably inside the first aperture and defining a second aperture disposed along a second axis, wherein the second axis is parallel to and is spaced apart from the first axis;
an inner eccentric element arranged rotatably inside the second aperture and defining a third aperture disposed along a third axis, wherein the third axis is parallel to and is spaced apart from each of the first and second axes;
a drill bushing arranged inside the third aperture and defining a fourth aperture disposed along a fourth axis, wherein the drill bushing is configured to swivel relative to the inner eccentric element to orient the fourth aperture relative to the first and second sides of the tooling plate; and
a system of fasteners configured to set the drill bushing in position relative to the first and second sides of the tooling plate for guiding a drill bit via the fourth aperture.

2. The drill template of claim 1, wherein the system of fasteners includes:
a drill bushing lock fastener configured to fix the drill bushing in position relative to the inner eccentric element;
an eccentric lock fastener configured to simultaneously fix each of the outer eccentric element and the inner eccentric element in position relative to the tooling plate; and
at least one bushing assembly lock fastener configured to fix the bushing assembly within the tooling plate in position relative to the first aperture.

3. The drill template of claim 2, wherein each of rotation of the outer eccentric element inside the first aperture, rotation of the inner eccentric element inside the outer eccentric element, and swiveling of the drill bushing inside the inner eccentric element adjusts the position of the drill bushing relative to the tooling plate.

4. The drill template of claim 3, wherein the third aperture includes a socket portion, and wherein the drill bushing includes a drill bushing body having a spherical portion configured to seat against and swivel within the socket portion.

5. The drill template of claim 4, the adjustable bushing assembly additionally includes a locking ring having an inner surface arranged adjacent the socket portion of the third aperture and configured to contact and lock the spherical portion of the drill bushing body via tightening of the drill bushing lock fastener.

6. The drill template of claim 5, wherein the drill bushing lock fastener is configured to tighten and fix the locking ring against the spherical portion of the drill bushing body.

7. The drill template of claim 2, wherein the eccentric lock fastener includes a conical portion.

8. The drill template of claim 7, wherein the eccentric lock fastener is a screw having a threaded shaft and a cap, and wherein the conical portion is a sleeve threaded onto the threaded shaft and seated against the cap of the eccentric lock screw.

9. The drill template of claim 7, wherein the adjustable bushing assembly additionally includes an eccentric lock bushing having an internal taper configured to engage the conical portion of the eccentric lock fastener and radial serrations configured to facilitate expansion of the eccentric lock bushing inside the outer eccentric element and against the inner eccentric element.

10. The drill template of claim 1, wherein the system of fasteners is configured to engage the tooling plate from the first side, and wherein the first aperture includes a step arranged proximate the second side and configured to provide a positive stop for the outer eccentric element along the first axis.

11. A drill template having an adjustable drill hole pattern, the drill template comprising:
a tooling plate having a first side, an opposite second side, and a plate thickness between the first and second sides, wherein the tooling plate defines a plurality of first apertures extending through the plate thickness along a respective first axis, and wherein the first axis is perpendicular to each of the first and second sides; and
a plurality of adjustable bushing assemblies configured to establish the adjustable drill hole pattern, wherein each adjustable bushing assembly includes:
an outer eccentric element arranged rotatably inside the respective first aperture and defining a second aperture disposed along a second axis, wherein the second axis is parallel to and is spaced apart from the first axis;
an inner eccentric element arranged rotatably inside the second aperture and defining a third aperture disposed along a third axis, wherein the third axis is parallel to and is spaced apart from each of the first and second axes;
a drill bushing arranged inside the third aperture and defining a fourth aperture disposed along a fourth axis, wherein the drill bushing is configured to swivel relative to the inner eccentric element to orient the fourth aperture relative to the first and second sides of the tooling plate; and
a system of fasteners configured to set the drill bushing in position relative to the first and second sides of the tooling plate for guiding a drill bit via the fourth aperture.

12. The drill template of claim 11, wherein the system of fasteners includes:
a drill bushing lock fastener configured to fix the drill bushing in position relative to the inner eccentric element;
an eccentric lock fastener configured to simultaneously fix each of the outer eccentric element and the inner eccentric element in position relative to the tooling plate; and
at least one bushing assembly lock fastener configured to fix the bushing assembly within the tooling plate relative to the first aperture.

13. The drill template of claim 12, wherein each of rotation of the outer eccentric element inside the first aperture, rotation of the inner eccentric element inside the outer eccentric element, and swiveling of the drill bushing inside the inner eccentric element adjusts the position of the drill bushing relative to the tooling plate.

14. The drill template of claim 13, wherein the third aperture includes a socket portion, and wherein the drill bushing includes a drill bushing body having a spherical portion configured to seat against and swivel within the socket portion.

15. The drill template of claim 14, wherein each adjustable bushing assembly additionally includes a locking ring having an inner surface arranged adjacent the socket portion of the third aperture and configured to contact and lock the spherical portion of the drill bushing body via tightening of the drill bushing lock fastener.

16. The drill template of claim 15, wherein the drill bushing lock fastener is configured to tighten and fix the locking ring against the spherical portion of the drill bushing body.

17. The drill template of claim 12, wherein the eccentric lock fastener is a screw having a threaded shaft and a cap and a conical sleeve threaded onto the threaded shaft and seated against the cap of the eccentric lock screw.

18. The drill template of claim 17, wherein each adjustable bushing assembly additionally includes an eccentric lock bushing having an internal taper configured to engage the conical sleeve of the eccentric lock fastener and radial serrations configured to facilitate expansion of the eccentric lock bushing inside the outer eccentric element and against the inner eccentric element.

19. The drill template of claim 11, wherein the system of fasteners is configured to engage the tooling plate from the first side, and the first aperture includes a step arranged proximate the second side and configured to provide a positive stop for the outer eccentric element along the first axis.

20. A drill template comprising:
a tooling plate having a first side, an opposite second side, and a plate thickness between the first and second sides, wherein the tooling plate defines a first aperture extending through the plate thickness along a first axis, and wherein the first axis is perpendicular to each of the first and second sides; and
an adjustable bushing assembly including:
an outer eccentric element arranged rotatably inside the first aperture and defining a second aperture disposed along a second axis, wherein the second axis is parallel to and is spaced apart from the first axis;
an inner eccentric element arranged rotatably inside the second aperture and defining a third aperture disposed along a third axis, wherein the third axis is parallel to and is spaced apart from each of the first and second axes;
a drill bushing arranged inside the third aperture and defining a fourth aperture disposed along a fourth axis, wherein the drill bushing is configured to swivel relative to the inner eccentric element to orient the fourth aperture relative to the first and second sides of the tooling plate; and
a system of fasteners configured to set the drill bushing in position relative to the first and second sides of the tooling plate for guiding a drill bit via the fourth aperture, wherein the system of fasteners includes:
a drill bushing lock fastener configured to fix the drill bushing in position relative to the inner eccentric element;
an eccentric lock fastener configured to simultaneously fix each of the outer eccentric element and the inner eccentric element in position relative to the tooling plate; and
at least one bushing assembly lock fastener configured to fix the bushing assembly within the tooling plate in position relative to the first aperture.
